(19) United States
(12) Patent Application Publication
(10) Pub. No.: US 2025/0183421 A1
(43) Pub. Date: Jun. 5, 2025

(54) POLYDOPAMINE DERIVED IRON DOPED HOLLOW CARBON NANORODS FOR SIMULTANEOUS GENERATION OF HYDROGEN AND ELECTRICITY

(71) Applicant: COUNCIL OF SCIENTIFIC AND INDUSTRIAL RESEARCH, New Delhi (IN)

(72) Inventors: Ajmal PANDIKASSALA, Pune (IN); Pranav Kanjirathingal GANGADHARAN, Pune (IN); Sreekumar KURUNGOT, Pune (IN)

(21) Appl. No.: 18/843,877

(22) PCT Filed: Mar. 2, 2023
(86) PCT No.: PCT/IN2023/050193

§ 371 Date: Sep. 4, 2024

(30) Foreign Application Priority Data
Mar. 4, 2022 (IN) 202211012039

(51) Int. Cl. H01M 12/06; H01M 4/90

(52) U.S. Cl. CPC H01M 12/06; H01M 4/9041; H01M 4/9083

(57) ABSTRACT

A hybrid energy system and process of preparation thereof to generate hydrogen and electricity simultaneously, which is cost effective. Provided is an iron-doped hollow carbon nanorod (FeHCNR) by utilizing polydopamine (PDA), as a potential bifunctional catalyst for empowering both hydrogen evolution reaction (HER) and oxygen reduction reaction (ORR). Further provided is a method of preparation of FeHCNR and use thereof in hybrid battery system for simultaneous generation of electricity and hydrogen.

### FIELD OF THE INVENTION

The present invention relates to polydopamine derived Iron doped Hollow Carbon Nanorods for simultaneous generation of hydrogen and electricity and the process for preparation thereof.

### BACKGROUND AND PRIOR ART OF THE INVENTION

Strict environmental regulations and growing thrust on the need for a switchover to green energy processes have generated significant attention on the development of efficient hydrogen generation and conversion systems. Even though hydrogen has been considered as one of the most promising and cleanest energy sources to replace the conventional fossil-based fuels, commercial scale production of green hydrogen is still a challenge and the process needs efficient scientific solutions. Among the potential routes available for the green hydrogen production, the electrochemical water splitting processes have made significant technological advancements. In a similar way, the electrochemical conversion of hydrogen using polymer electrolyte membrane fuel cells (PEMFCs) is an important process to harvest the electrical energy from the chemical energy available in hydrogen. However, both the electrochemical water splitting process and energy production by PEMFC need significant improvement with respect to efficiency and operational cost. Recently, researchers have developed new concepts like Li—H₂O fuel cell, [Z. Guo, Y. Wang, Y. Song, C. Li, X. Su, Y. Wang, W.-b. Cai, Y. Xia, ACS Energy Letters 2017, 2, 36] and Zn—H₂O fuel cell [P. Cai, Y. Li, G. Wang, Z. Wen, Angewandte Chemie International Edition 2018, 57, 3910] which can simultaneously generate electricity and produce hydrogen. Alkaline-acid Zn—H₂ hybrid battery is a device similar to Zn—H₂O cell in which the neutralization process between the acid and base and the Zn oxidation energy can be concurrently harvested electrochemically The ability of the as-built hybrid battery to produce hydrogen and energy at the same time has been confirmed. Apart from the generation of fuel during the production of electricity, the Zn—H₂ hybrid battery has an extra advantage of utilization of the neutralization energy of water, which causes rise in the energy density and the voltage output of the system compared to the conventional Zn-air batteries.

Another class of emerging hybrid device is the asymmetric electrolyte Zn-air battery (AEZAB) which has the capability to deliver higher performance compared to the conventional Zn-air battery (ZAB). The additional utilization of neutralization energy makes AEZAB more fascinating over typical ZAB in the prospects of the future energy generation.

However, the demonstrations of such devices have been performed by employing expensive catalysts and separators. Until now, the Pt and Pt-based electrocatalysts have been perceived to be the best for the hydrogen evolution reaction (HER), and oxygen reduction reaction (ORR) which are the important processes involved in the electrochemical production and utilization of hydrogen. However, along with their exorbitant cost, unsatisfactory durability under the working conditions of the electrochemical systems, possesses major operational concerns. Therefore, exploration on the designing of more cost-effective and durable catalysts for these applications is a topic of significant importance of the time. Many activities are done for developing potential non-noble metal-based HER and ORR catalysts, including phosphide and sulphide based materials.

Even though many of these catalysts show better activities for HER and ORR, they could not so far come as credible replacements to the state-of-the-art catalysts. Fe—N species with suitable carbon supports have attracted considerable attention in catalyzing both HER and ORR. Iron-coordinated nitrogen linkage (Fe—Nₓ) and particular types of nitrogen species are supposed to be efficient active centers with unique intrinsic activities to facilitate electrochemical adsorption followed by reduction of the reactants. It has been widely proven that along with the composition, the morphology of the substrate also holds a decisive part in determining the overall performance characteristics pertaining to the device level applications. Considering the compositions of the nitrogen-based heteroatom sites for HER and ORR, doping of nitrogen is found to be an effective strategy for building the active sites. Charged sites are formed on the carbon sites due to the presence of highly electronegative nitrogen atoms, which profit both charge and mass transfer during the HER and ORR processes. To further exploit the electrocatalytic activity of the materials, synthetic methods that lead to improved exposure and better accessibility of the active sites are worth studying. In this context, fine-tuning the surface area of the catalysts by hosting hollow structures with anchored active sites along the inner as well as the outer surfaces is anticipated to construct more exposed electrochemically active centers along with better feasibility for mass transport compared to the analogous bulk materials. Therefore, designing of hollow structured HER-ORR bifunctional electrocatalysts with adequately coordinated Fe—Nₓ active sites has been considered to an interesting approach. With this intention, several nitrogen-containing small organic molecules have been extensively applied in the development of N-doped hollow carbon materials.

As is evident from the foregoing research analysis, hydrogen is one of the most promising and cleanest sources of energy to replace conventional fossil-based fuels due to its numerous advantages and also simultaneous generation of electricity along with the production of hydrogen fuel is getting attention nowadays. However, the development of such devices is done in the prior arts, with commercial noble metal catalyst, organic electrolytes and high-cost separators, which hinders its commercialization. Further, the electrocatalysts based on platinum and platinum alloys are severely restricted by high cost, poor stability and crossover effect. Also, there are safety issues related to the use of organic electrolyte, low efficiency of hydrogen generation, usage of the costly separator. Hence, replacement of the existing systems with low-cost alternatives is required to overcome the above problems, which eventually reduce the total cost of the system and improve the efficiency of hydrogen and electricity generation as well.

In the light of the above, there remains a need in the art to develop a simple method and a hybrid energy system to generate hydrogen and electricity simultaneously, which is cost effective.

### OBJECTS OF THE INVENTION

In the light of the foregoing, it is an objective of the present invention to provide a hybrid energy system to generate hydrogen and electricity simultaneously, which is cost-effective.

An important objective of the present invention is to provide a bifunctional electrocatalyst comprising of a Iron-doped hollow carbon nanorod (FeHCNR), for simultaneous generation of hydrogen and electricity.

It is an objective of the present invention to provide iron-doped hollow carbon nanorod (FeHCNR) as potential bifunctional catalyst for empowering both HER and ORR.

Another objective of the invention to provide a process for preparation of iron-doped hollow carbon nanorod (FeHCNR) by utilizing polydopamine (PDA).

Yet another objective of the present invention is to provide alkaline-acid Zn—H₂ hybrid battery and asymmetric-electrolyte Zn-air battery comprising polydopamine derived iron-doped hollow carbon nanorod (FeHCNR) coated on the surface of the cathode for simultaneous generation of hydrogen and electricity.

Yet another objective of the present invention is to provide a hybrid energy system for generation of hydrogen and electricity simultaneously using non-noble metal catalyst.

### SUMMARY OF THE INVENTION

In line with the above objective, the present invention provides Fe—Nₓ-based hollow nanorod by utilizing polydopamine (PDA), a kind of melanin-like small organic molecule that contains enormous amine and catechol groups, as a potential bifunctional catalyst for empowering both HER and ORR. Coordination bonds allow the PDA to attach to metallic ions. Metallic ions can also covalently interact with the amine groups of PDA via Schiff base or Michael addition reactions, which is the important advantage of the compound to gain the attention towards this exercise. In addition to the above advantages, PDA also assists as a decent source of C and N. The homogenous distribution of the metal nanoparticles and the simultaneous doping of heteroatoms are accredited to these chemical features of PDA.

In an important aspect of the present invention, the present invention relates to a bifunctional electrocatalyst for a simultaneous generation of hydrogen and electricity comprising of an iron-doped hollow carbon nanorod (FeHCNR), wherein an iron metal in the FeHCNR comprises of mixed phases of Fe₃C and a Fe₃N and wherein the FeHCNR has a mesoporous structure with a BET surface area of 202-204 m²g⁻¹ and a total pore volume of 0.42-0.44 cm³ g⁻¹.

In an embodiment of the present invention, the bifunctional electrocatalyst has an open-tube cavity and high density of the active sites exposed along with outer and inner walls to improve mass diffusion along with the electrocatalytic activity.

In another aspect, the present invention provides a process for preparation of the iron-doped hollow carbon nanorod (FeHCNR), the process comprises the steps of:
a) Reacting ZnO nanorod and FeCl₃ in a bicarbonate buffer (pH of 8.5) solution containing dopamine hydrochloride under stirring at temperature ranging from 25-30° C., to obtain polydopamine (PDA) covered ZnO nanorods (FePDAZnO);
b) Adding the separated PDA covered ZnO nanorods (FePDAZnO) to solution of NH₄Cl under stirring at 55-65° C., to etch out ZnO template and to obtain ZnO-free iron doped PDA nanorods; and
c) Annealing the ZnO-free iron doped PDA nanorods at 780-820° C. under Ar atmosphere for 1.8-2.2 h followed by treatment with H₂SO₄ at 55-65° C. to obtain FeHCNR.

Further, by adopting a unique synthesis process as discussed above, a hollow structured PDA derived carbon nanorod with Fe—Nₓ active centers (FeHCNR) is designed.

In another aspect of the present invention, the process for preparation of an iron-doped hollow carbon nanorod (FeHCNR), comprising the steps of:
a) mixing a Zinc salt, Surfactant, and a buffer by ultrasonication for about 25-35 minutes at temperature ranging from 25-30° C.;
b) autoclaving the mixture of step a) for 11-13 hours at temperate ranging from 115-125° C.;
c) washing the product of step b) with a distilled water and a solvent to obtain a white powder;
d) drying the white powder obtained in step c) in a vacuum oven at temperate ranging from 55-65° C.;
e) dissolving the dried white powder of step d) in a solution comprising of FeCl₃ in a bicarbonate buffer (pH of 8.5) solution containing a dopamine hydrochloride;
f) stirring the solution mixture of step e) at temperate ranging from 25-30° C. for time period of 55-65 minutes to obtain a polydopamine covered ZnO nanorods (FePDAZnO);
g) centrifuging the FePDAZnO of step f) followed by rinsing with a solvent;
h) vacuum-drying the product of step g);
i) mixing the dried product of FePDAZnO obtained from step h) into aqueous solution of NH₄Cl to form a suspension which is further stirred for 18-22 minutes at temperate ranging from 55-65° C. to get a ZnO-free iron-doped PDA nanorods;
j) centrifuging the ZnO-free iron-doped PDA nanorods obtained from step i) followed by washing with water, and subsequent drying using a vacuum oven at temperate of 60° C.;
k) annealing the material obtained from step j) at temperate of 800° C. for 2 hours, followed by a treatment with H₂SO₄ at temperate of 60° C. to eliminate a non-reactive and a unstable residues; and
l) washing the material of step k) with water followed by drying to obtain pure FeHCNR.

In an embodiment of the present invention, the zinc salt is selected from but not limited to zinc acetate dihydrate, zinc sulfate and so on; the surfactant is selected from but not limited to poly (ethylene glycol), diethylene glycol and so on; and the buffer is selected from but not limited to NaOH, KOH and so on.

In an embodiment of the present invention, the first solvent used for washing in step c) is ethanol and the second solvent for step g) is water.

In another aspect of the present invention, an alkaline-acid Zn—H₂ hybrid battery comprising:
a) FeHCNR brush-coated on the surface of a carbon paper as a cathode;
b) a catholyte;
c) a Zn plate as a anode; and
d) an anolyte;

In an embodiment of the present invention, the FeHCNR acts as a bifunctional electrocatalyst for the simultaneous generation of hydrogen and electricity by asymmetric electrolysis with the acid catholyte and alkaline anolyte; wherein the acid catholyte is 2M H₂SO₄ and alkaline anolyte is 4M NaOH.

In another embodiment, the bifunctional electrocatalyst is a noble metal-free catalyst.

Thus, the derived FeHCNR catalyst is exhibited very good activity towards both ORR and HER in acidic conditions with outstanding stability under electrochemical environment. In another aspect, the performance of the catalyst for HER has been evaluated by employing the material as the cathode in a new type of Zn—H₂ hybrid battery which shows an interesting advantage of simultaneous production of electricity and hydrogen fuel. It has been further verified that the FeHCNR, provided according to the invention can serve also as a low-cost ORR catalyst for asymmetric-electrolyte Zn-air battery (AEZAB).

The acid-base Zn—H₂O fuel cell provided according to the present invention gives better and consistent cell performance with the generation of hydrogen fuel. Moreover, the use of non-noble metal catalyst based on iron coordinated to nitrogen to serve as the most efficient centres for significantly accelerating the reaction kinetics.

### BRIEF DESCRIPTION OF THE DRAWINGS

FIG. 1: (a) FE-SEM and (b) TEM images of FePDAZnO; (c, d) FE-SEM images of FeHCNR with different magnifications, and (e and f) TEM images of FeHCNR with different magnifications.

FIG. 2: (a) XRD patterns of ZnO and FeHCNR, (b) Raman spectra of FeHCNR and ZnO, and (c) TGA profile of FeHCNR.

FIG. 3: Deconvoluted (a) Fe 2p, (b) C 1s, and (c) N 1s XPS spectra of FeHCNR and (d) bar diagram representing the different types of nitrogen and their atomic percentages obtained from the N 1s spectrum of FeHCNR.

FIG. 4: (a) BET isotherms, and (b) pore-size distribution profiles of FePDCZnO and FeHCNR

FIG. 5: Comparative LSVs recorded for HER in 1 M H₂SO₄ electrolyte at scan rate of 10 mV s⁻¹

FIG. 6: (a) Comparative LSVs corresponding to ORR in 0.5 M H₂SO₄ at scan rate of 10 mV s⁻¹

FIG. 7: (a) The plots representing the voltage vs. specific capacity of FeHCNR and Pt/C (20%) based Zn—H₂ hybrid battery, (b) the voltage (left y-axis)-current density and power density (right y-axis)-current density plots obtained from the FeHCNR and Pt/C (20%) based Zn—H₂ hybrid battery systems, (c) hydrogen production as a function of the time recorded at the discharge current density of 5 mA cm⁻² and (d) the corresponding Faradic efficiencies calculated for the as-proposed Zn—H₂ hybrid battery as a function of the time.

FIG. 8: a, b) The FESEM images of ZnO nanorods highlighting the length and width of the tubes and c) the TEM image of the ZnO nanorods.

FIG. 9: Elemental mapping of FeHCNR indicating the uniform distribution of iron, nitrogen, and carbon

FIG. 10: XPS survey spectrum of FeHCNR

FIG. 11: LSVs of Pt/C recorded before and after ADT in 0.5 M H₂SO₄ at a scan rate of 10 mV s⁻¹ and an electrode rotation speed of 1600 rpm.

FIG. 12: The open circuit voltage recorded for 30 min. for FeHCNR based AEZAB and conventional ZAB (CZAB)

FIG. 13: A schematic illustration of the preparation of the FeHCNR electrocatalyst and its system-level demonstrations for the Zn—H₂ hybrid battery and Assymetric Electrolyte Zinc-Air Batteries.

### DETAILED DESCRIPTION OF THE INVENTION

The present invention will now be described in detail in its preferred and optional embodiments so that the various aspects therein can be more clearly understood and appreciated.

The present invention describes the various terms and the meaning of the same bound to their full form is provided herein below:
FeHCNR: Iron (Fe) with hollow carbon nanorod
FePDAZnO: Iron (Fe) with Polydopamine covered Zinc oxide nano tube
FePDCZnO: Iron (Fe) with Polydopamine derived carbon covered Zinc oxide nano tube
ZnONR: Zinc oxide nanorod.
Catholyte (plural catholytes): The portion of an electrolyte which contains cathode, especially in a cell in which the cathode and anode are in separate compartments.
Anolyte (plural anolytes): The portion of an electrolyte consists of anode, especially in a cell in which the cathode and anode are in separate compartments.

The terms such as electrocatalyst, catalyst, bifunctional catalyst, with respect to the catalyst FeHCNR bear the same meaning throughout the specification and are used interchangeably throughout the description of the invention.

In an embodiment, the present invention provides iron-doped hollow carbon nanorod (FeHCNR) by utilizing polydopamine (PDA), as a potential bifunctional catalyst for empowering both HER and ORR. The use of non-noble metal catalyst based on Iron coordinated to nitrogen-groups to serve as the most efficient centers for significantly accelerating the reaction kinetics.

In an aspect, the present invention provides a bifunctional electrocatalyst for the simultaneous generation of hydrogen and electricity comprising of Iron-doped hollow carbon nanorod (FeHCNR). The FeHCNR as disclosed in the present invention contains mixed phases of Fe₃C and Fe₃N and wherein the FeHCNR has a mesoporous structure with a BET surface area of 202-204 m² g⁻¹ and a total pore volume of 0.42-0.44 cm³ g⁻¹

In another aspect, the present invention provides process for preparation of the iron-doped hollow carbon nanorod (FeHCNR) or preparing a bifunctional electrocatalyst, comprising:
a) Mixing Zinc salt, surfactant, and buffer by ultrasonication for about 20-40 minutes at a temperature ranging from 25-30° C.;
b) autoclaving the mixture of step a) for 11-13 hours at 115-125° C.;
c) washing the product of step b) five times with distilled water and solvent to obtain white powder;
d) drying the white powder obtained in step c) in a vacuum oven at temperature ranging from 55-65° C.;
e) dissolving dried white powder of step d) in solution of 1 mM FeCl₃ in bicarbonate buffer (pH of 8.5) solution containing 9-11 mg of dopamine hydrochloride to obtain PDA covered ZnO nanorods;
f) stirring the above solution of step e) at temperature of 25-30° C. for 55-656 minutes to obtain Polydopamine covered ZnO nanorods (FePDAZnO);
g) centrifuging the obtained FePDAZnO of step f) followed by rinsing with water;
h) vacuum-drying the obtained product of step g);
i) mixing dried product of FePDAZnO obtained from step h) into 2 M aqueous solution of NH₄Cl to form a suspension which is then stirred for 15-25 minutes at 55-65° C. to obtain ZnO-free iron-doped PDA nanorods;
j) centrifuging the ZnO-free iron-doped PDA nanorods obtained from step i) followed by washing with deionized water, and drying using a vacuum oven at 55-65° C.;
k) annealing the material obtained from step j) at 780-820° C. under an argon (Ar) atmosphere for 1.8-2.2 hours, followed by the treatment with 0.5 M H₂SO₄ at 55-65° C. to eliminate the non-reactive and unstable residues;
l) washing the obtained material of step k) three times with water followed by drying to obtain FeHCNR.

During the reaction of steps, as the pH induced oxidation progresses, the color of the solution gradually turned dark brown and the dopamine gets self-polymerized over the ZnO to form PDA covered ZnO nanorods (FePDAZnO). The FePDAZnO thus obtained was separated by centrifugation before being rinsed with deionized water. The obtained product was then vacuum dried at ambient temperature.

In the step to etch out the ZnO template, FePDAZnO was added into a 2 M aqueous solution of NH₄Cl and the suspension was kept under stirring for 20 minutes at 60° C. Further, the ZnO-free iron doped PDA nanorods are obtained by centrifugation, washing with deionized water and drying using a vacuum oven at 60° C.

In the last step, ZnO-free iron doped PDA nanorods were subsequently annealed at 800° C. under Ar atmosphere for 2 hours followed by treatment with 0.5 M H₂SO₄ at 60° C. to eliminate the non-reactive and unstable residues. The material thus obtained was washed with water and dried to obtain FeHCNR.

In an embodiment of the present invention, the zinc salt as disclosed in step a) of the present invention is Zinc acetate dehydrate.

In an embodiment of the present invention, the surfactant as disclosed in step a) is poly(ethylene glycol).

In an embodiment of the present invention, the buffer as disclosed in step a) is NaOH

In another embodiment, for a comparative study, a control sample without a hollow structure was prepared by directly annealing the sample Iron (Fe) with Polydopamine covered Zinc oxide nano tube (FePDAZnO) at 800° C. under Ar atmosphere for 2 hours and the obtained sample is named as Iron (Fe) with Polydopamine derived carbon covered Zinc oxide nano tube (FePDCZnO) and studied the morphology of both FeHCNR as well as FePDCZnO. It has been observed while FeHCNR has a hollow tubular morphology with the well-coordinated Fe—Nₓ type active sites exposed along the inner and outer walls of the rods; the ZnO core present in the FePDCZnO lacks the hollow nature and its active sites are exposed only along the outer surface.

In another embodiment, the Zn nanorods are prepared by reacting Zn(OAc)₂.2H₂O, and PEG-400 in presence of NaOH in ethanol under ultrasonication for about 30 min at room temperature. Subsequently, the reaction mixture was kept at 120° C. for 12 hours in a 50 mL Teflon-lined stainless-steel autoclave. The resulting product (Zn nanorods) thus obtained was washed with distilled water and ethanol and dried in a vacuum oven at 60° C.

Thus, the zinc oxide nanorods (ZnONR) synthesized by a solvothermal method reported previously was used as the template for the preparation of the hollow carbon nanorods. The dopamine was self-polymerized over the surface of the obtained ZnONR template under a weak alkaline condition with an iron precursor to form iron coordinated polydopamine nanorods (FePDAZnO). The slow polymerization ensures the complete coverage of the polydopamine layer over the ZnONR template, leading to the formation of a bilayer structure. Further, the iron incorporated hollow polydopamine nanorod architecture was attained by the removal of the ZnONR template. The 2 M NH₄Cl used for the removal of the template selectively reacts with the Zn and etches away ZnO by leaving the outer layer intact. The etching of the ZnO nanorod template holds a significant part in the development of the hollow structure of FeHCNR. The neutral nature of ZnO helps to dissolve in either basic or acidic solution. Since PDA contains a huge number of basic amino groups, it is not a decent acid-resistant substance. In contrast, it can be dissolved in a basic solution. Therefore, to maintain the morphology of PDA as such, it is essential to follow a new approach to etch out the ZnO template in a solution with neutral pH. The experimental results show that 2 M NH₄Cl aqueous solution with a usual neutral pH of 6.5 is a perfect etching agent for Zn. Subsequent high-temperature annealing of the hollow polydopamine shell coordinated with Fe³⁺ ions transform the matrix into the iron-doped hollow carbon nanorods enriched with the Fe—Nx active sites. During the course of the high temperature annealing, the PDA gets converted into graphitic carbon which has nitrogen and iron coordination in its matrix, respectively generated from the amino group of the dopamine and the iron precursor. The graphitization helps the material to achieve electrical conductivity, which is important for ensuring the electrocatalytic functioning of the system. The characterization of the FeHCNR further discussed herein below.

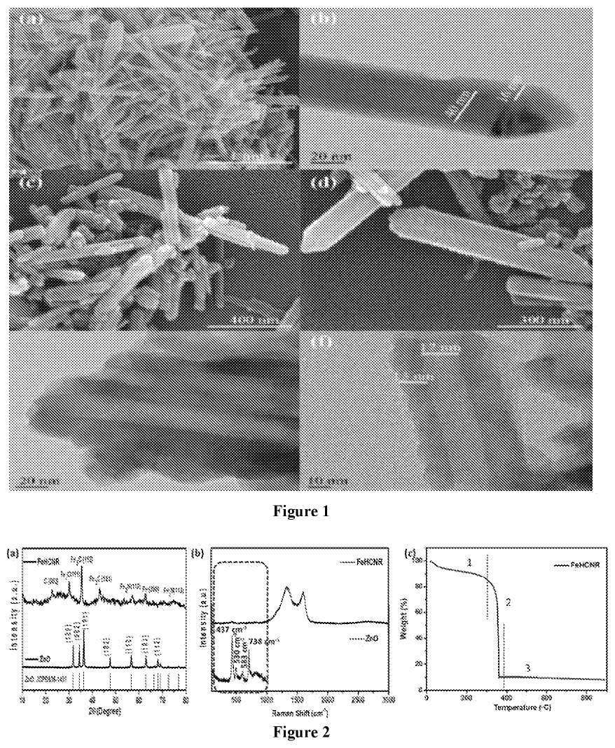

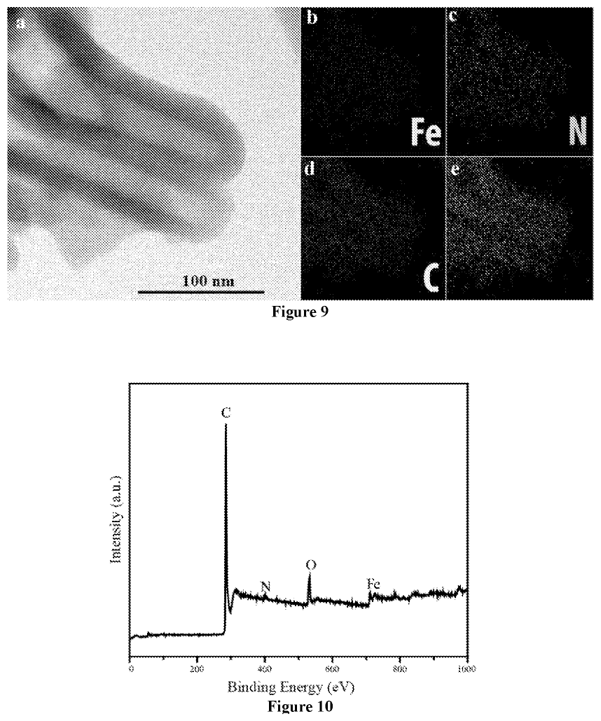

FIGS. 1a and b show the FESEM and TEM images of FePDAZnO, respectively. The bilayer structure of FePDAZnO has a rod-like morphology since it is formed from the ZnONR template. The thin layer coating of the polydopamine layer differentiates FePDAZnO from ZnONR. The FESEM and TEM images of ZnO given in FIG. 8 clearly depicts the rod-like morphology of the template material. The prepared nanorods have length of 100 to 500 nm and diameter of ˜40 nm. However, FePDAZnO has an extra layer of polydopamine coating, which is having a thickness of around 16 nm (FIG. 1b). Further, the FESEM images of FeHCNR with different magnifications as shown in FIG. 1c and d illustrate the retention of the rod-like morphology of the parent sample (i.e., FePDAZnO) even after the high-temperature annealing. In the TEM images presented in FIGS. 1e and f, the hollow nature is clearly visible. The inner diameter of the rods in FeHCNR is about 17 nm, with the length ranging from 100 to 500 nm, while maintaining the wall thickness of about 13 nm. It should be noted that, subsequent to the high temperature annealing, the diameter of the nanorod gets reduced to half from 40 nm to about 17 nm due to the thermal stress exerted on the material during the annealing process. The TEM image of FeHCNR does not reveal the presence of any trapped particles originated from the iron moiety. In FIG. 9, the EDS mapping of FeHCNR confirms that the elements C, N and Fe are distributed uniformly on the hollow carbon structure. The removal of ZnO nanorods by NH₄Cl is found to be decreasing the uniformity of the tubular morphology to a certain extent.

X-ray diffraction (XRD) analysis has been performed to find out the crystal phase characteristics of FeHCNR. The comparative XRD profiles of the ZnO nanorod and FeHCNR are presented in FIG. 2a. The graphitic carbon's (002) plane of FeHCNR can be assigned to the broad peak appeared at 23.1°. This points towards the attainment of the graphitic carbon phase from the parent hollow PDA nanorods due to the high temperature annealing at 800° C. All the remaining sharp diffraction peaks from 30° to 70° present in FeHCNR are in well agreement with the signature peaks corresponding to the different phases of Fe₃C ((Joint Committee on Powder Diffraction Standards (JCPDS) No. 35-0772). There are other two notable peaks appeared at 56.7 and 75.8°, which could be attributed to Fe₃N (JCPDS No. 01-072-2125). Also, it is worth noting that there was no peak corresponding to metallic iron in the XRD profile of FeHCNR, and, thus, it could be confirmed that the post synthesis acid washing ensured the removal of the unreacted metal impurities from the system. X-ray diffraction (XRD) analysis has been performed to find out the crystal phase characteristics of FeHCNR. The comparative XRD profiles of the ZnO nanorod and FeHCNR presented in FIG. 2a. The graphitic carbon's (002) plane of FeHCNR can be assigned to the broad peak appeared at 23.1°. This point towards the attainment of the graphitic carbon phase from the parent PDA hollow nanorods due to the high temperature annealing at 800° C. All the remaining sharp diffraction peaks from 30° to 70° present in FeHCNR are in well agreement with the signature peaks corresponding to the different phases of Fe₃C ((Joint Committee on Powder Diffraction Standards (JCPDS) No. 35-0772). There are other two notable peaks appeared at 56.7 and 75.8°, which could be attributed to Fe₃N (JCPDS No. 01-072-2125). Also, it is worth noting that there was no peak corresponding to metallic iron in the XRD profile of FeHCNR, and, thus, it could be confirmed that the post synthesis acid washing ensured the removal of the unreacted metal impurities from the system. The XRD characterization discloses that the iron in FeHCNR contains mixed phases of Fe₃C and Fe₃N. The existence of both these iron moieties together can help the system to acquire the bifunctional characteristics to work as an efficient electrocatalyst for facilitating HER and ORR. The XRD pattern of ZnONR is in well agreement with the standard ZnO patterns (JCPDS no. 36-1451). On comparing the XRD profile of FeHCNR with the ZnO template, it could be observed that there are no common peaks in both the samples and this ensures the successful removal of the ZnO template by the NH₄Cl assisted leaching method.

The degree of graphitization of the material considerably impacts the electrical conductivity of the system, which is essential in delivering the electrocatalytic performance. The degree of graphitization of FeHCNR has been examined by Raman spectral elucidation. The Raman spectral analysis is being widely performed to understand the structural information regarding distorted, graphitic, amorphous or crystalline carbon phases present in the system. The bond stretching of the sp² hybridized carbon atoms of the hexagonal graphitic rings causes the G band to emerge at 1594 cm⁻¹, while the D band at 1344 cm⁻¹, resulting from the distorted carbon frames on the defect sites. In the proportionality term, the ratio of the intensities of the D band to the G band (I_{D}/I_{G}) provides information about the degree of distortion of the carbon structure; with the increasing degree of distortion, the I_{D}/I_{G} increases. The catalyst shows an I_{D}/I_{G} ratio of 1.20, implying a greater disorder (FIG. 2b). High heteroatom loading, such as nitrogen, is known to cause stress in the lattice, resulting in increased disorder in the system. Also, the observed broad D band, as compared to that of the reported carbon nanotubes, may be ascribed to the development of amorphous porphyritic carbon layer on the surface. The Raman spectrum of ZnO nanotube is also shown in FIG. 2b. A strong and narrow peak is seen at 437 cm⁻¹, which has been allocated to one of the two E2 modes relating the important feature of the Zn motion of the Wurtzite phase of ZnO. Along with this, a weak band corresponding to the E1 mode of ZnO accompanied by the deficiency of oxygen is appeared at 530 cm⁻¹. The other associated characteristic peaks of ZnO appeared at 583 and 738 cm⁻¹ are ascribed to the E1 and B1 modes, respectively. However, it should be noted that, the peaks corresponding to Zn are completely absent in the case of FeHCNR, implying complete removal of Zn through the NH₄Cl treatment.

The amount of inorganic residue originating from the FeHCNR was measured by thermogravimetric analysis (TGA) in the oxygen environment. The TGA profile recorded in the O₂ atmosphere for the catalyst (FIG. 2c) represents three distinct weight-loss regions. The weight reduction between 100 and 280° C. in the thermogram is ascribed to the decomposition and dehydration of the functional groups present on the carbon surface. The second weight-loss region corresponds to the combustion of amorphous and microcrystalline carbon (around 10 wt. %). The weight loss after 360° C. is attributed to the decomposition of Fe₃N to first to metallic Fe and graphite, followed by the oxidation of Fe to give iron-oxide with the concomitant decomposition of the carbon. The final residue is calculated to be about 8.5 wt. %, which is attributed to the total amount of iron in the system converted to the oxide form.

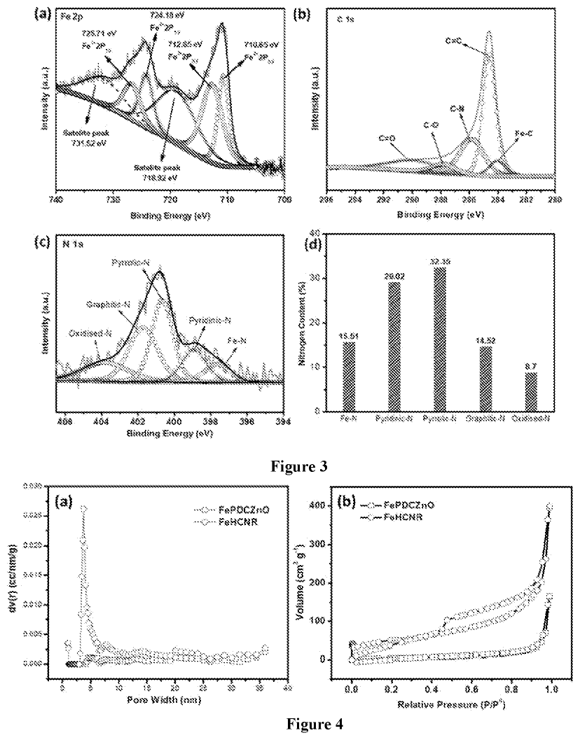

The elemental compositions and chemical states of FeHCNR were analyzed using X-ray photoelectron spectroscopic (XPS) studies, which would have a direct impact on the electrochemical performance of the catalyst. The XPS survey spectra of FeHCNR are shown in (FIG. 10), confirming the existence of C, N, O, and Fe elements. The assessed atomic percentages of C, N, O and Fe are 88.49, 2.85, 7.08 and 1.58%, respectively. The deconvoluted Fe 2p spectrum for FeHCNR (FIG. 3a) shows noticeable peaks centered at 726.7 and 724.2 eV, which are assigned to the Fe 2p_{1/2} of Fe (III) and Fe (II), respectively.

Other two peaks appeared at the binding energies of 712.6 and 710.6 eV are attributed respectively to the 2p_{3/2} state of Fe (III) and Fe (II). Also, their corresponding satellite peaks are appeared at 731.5 and 718.9 eV. This result indicates the co-existence of Fe (II) and Fe (III) atomic states in FeHCNR. The existence of the Fe—Nₓ bonding, which accounts for a considerable fraction of the overall Fe content, is shown by the weak doublets for the Fe 2p_{3/2} signals appearing at 710.6 and 712.6 eV. The deconvoluted C Is XPS spectrum of the catalyst (FIG. 3b) shows five peaks. The sp2 hybridized graphite like carbon atoms (C═C) are responsible for the main peak at 284.6 eV. The C—O and C═O species are represented by the other peaks at 287.7 and 289.2 eV, respectively. The peak centered at 286.3 eV, which is for the C—N bond, serves as a valid evidence on the incorporation of N heteroatoms in the carbon lattice. This has a significant impact on the electrochemical performance of the systems. Along with this, the relatively high content of the sp2 hybridized carbon (55.7 at. %) verifies the high degree of graphitization, which also is an important performance deciding parameter. The degree of graphitization directly relates to the electrical conductivity, and better graphitization helps to reduce the iR drop during the current (i)-voltage (V) polarization experiments. Apart from the previously mentioned carbon XPS peaks, a peak with low intensity is observed at 284.9 eV. This peak is attributed to the iron-carbon coordination and points towards the formation of a small extent of iron carbides during the high temperature annealing process.

Furthermore, the high-resolution N 1s spectrum (FIG. 3c) was deconvoluted into five peaks corresponding to the Fe—N (397.6 eV), pyridinic N (398.9 eV), pyrrolic N (400.6 eV), graphitic N (401.7 eV), and oxidized N (403.8 eV) states present in the catalyst matrix. The quantitative depiction of all the distinct forms of nitrogen species present in the catalyst is shown in FIG. 3d as a bar diagram. The nitrogen atoms doped at the margins of the graphitic carbon layers are represented by the pyridinic nitrogen. Besides, the lone pairs of electrons of the pyrrolic nitrogen and pyridinic atoms help to coordinate with the Fe to form the Fe—Nₓ active sites. As the binding energies of Fe—N and pyridinic nitrogen are so close, the peak at 398.9 eV also includes an input from the nitrogen bound with the Fe atoms. The graphitic N is characterized as that which is doped inside the graphitic carbon plane, whereas the pyrrolic N is defined as that which is doped within a five-membered heterocyclic ring. The quantification mapping confirms that the nitrogen atoms are effectively doped in the carbon framework by substituting the carbon atoms situated both at the edges and within the graphitic carbon layers. Earlier reports show that, nitrogen's high electron affinity property in the carbon layer can bring positive charge density on the neighboring C atoms, enabling oxygen adsorption and, thereby, weakening the bonding of the oxygen molecule. Both the graphitic N and pyridinic N have been found to play crucial roles in enhancing the ORR activity. The greater current density, spin density, and density of the x states of the C atoms around the Fermi level can all be attributed to the high pyridinic N content. Also, the graphitic N is unequivocally identified with the ability to facilitate ORR through the favorable four-electron (4e) transfer process.

The Brunauer-Emmett-Teller (BET) surface area and total pore volume of FeHCNR and FePDCZnO counterpart were measured from the nitrogen adsorption-desorption analysis. FIG. 4a shows the N₂ adsorption-desorption isotherms of FeHCNR and FePDCZnO, which show typical Type-IV characteristics, indicating the materials' dominant mesoporosity. FIG. 4b shows the pore-size distribution patterns of FeHCNR and FePDCZnO. The FeHCNR has high density of pores in the region of 3.0-4.5 nm, indicating that the system is mesoporous. FeHCNR has a BET surface area of 203 m² g⁻¹ and a total pore volume of 0.43 cm³ g⁻¹, while FePDCZnO has a surface area of 21.3 m² g⁻¹ and a total pore volume of 0.12 cm³ g⁻¹. In comparison to its non-hollow counterpart FePDCZnO, FeHCNR exhibits the desired mesoporous structure with 9 times higher surface area and large pore volume. These results suggest that introducing and then removing the ZnO nanorod template can significantly increase the specific surface area of the catalyst. The high surface area benefits wider exposure of catalytically actives sites, and the mesoporous texture can provide facile channels for transporting gas molecules and diffusion of ions during the HER and ORR processes.

### Hydrogen Evolution Reaction (HER)

In a 0.5 M H₂SO₄ solution, the electrochemical activities of the as-prepared materials were initially investigated for HER using a rotating disc electrode (RDE) set-up connected to a potentiostat (BioLogic SP-300). The working electrode was a glassy carbon electrode with a working area of 0.196 cm² coated with FeHCNR. A graphite rod and Hg/HgSO₄ were used as the counter electrode and reference electrode, respectively, throughout the electrochemical analysis. At a scan rate of 10 mV s⁻¹, the linear sweep voltammetry (LSV) was performed in a N₂-saturated 0.5 M H₂SO₄ solution. Before the LSV measurements, to stabilize and activate the electrocatalyst, about 50 cycles of cyclic voltammetry (CV) were performed with a scan rate of 30 mV s⁻¹ in the potential window of −0.15 to 0.15 V (vs. the reversible hydrogen electrode, RHE). All the LSV measurements were executed with 90% iR correction. FIG. 5 shows the HER data for all of the as-synthesized catalysts as well as the state-of-the-art Pt/C (20%) catalyst. As displayed in the FIG. 5a, the ZnO template used for the preparation of FeHCNR shows negligible activity towards HER. To achieve a current density of 50 mA cm⁻², the catalyst synthesized without the use of a template (FePDC) has shown an overpotential value of 172 mV. FePDCZnO (the material having the ZnO template) exhibits an overpotential value of 75.5 mV at 50 mA cm⁻². It is worth noting that the material derived after the ZnO template removal (i.e., FeHCNR) has excellent performance characteristics, with an overpotential of only 29.4 mV at a current density of 50 mA cm⁻². It is to be noted that the performance of FeHCNR is nearly comparable to that of the state-of-the-art Pt/C catalyst, which requires an overpotential of 18.2 mV to achieve the benchmark current density of 50 mA cm⁻².

### Oxygen Reduction Reaction (ORR)

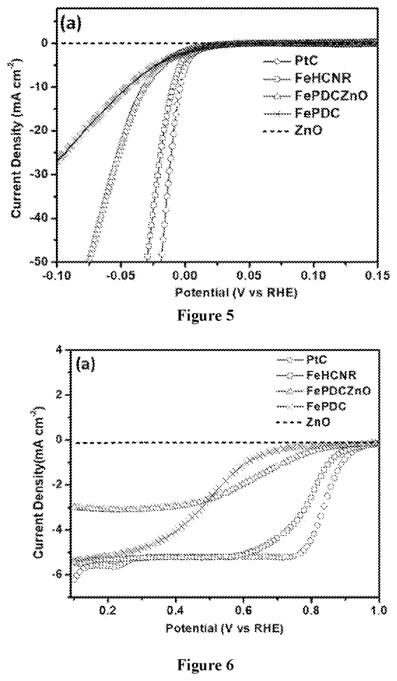

In addition to serving as a remarkable HER electrocatalyst in acidic media, FeHCNR was found to exhibit good oxygen reduction reaction (ORR) performance in acidic environment. To evaluate the ORR performance of the catalyst, LSV polarization analysis was performed on an RDE at 1600 rpm of the working electrode and 10 mV s⁻¹ in an O₂ saturated 0.5 M H₂SO₄ electrolyte. The LSVs of all the samples and the state-of-the-art 40 wt. % Pt/C catalyst are shown in FIG. 6a. The onset potential and half-wave potential (E_{1/2}) of the bulk FePDC catalyst, which is prepared without any template, are 0.75 V and 0.49 V against RHE, respectively, indicating minimal ORR activity. On the other hand, FePDCZnO with the rod like morphology exhibits better ORR performance compared to the bulk phase FePDC catalyst. FePDCZnO exhibits the potential values of 0.93 V and 0.64 V vs. RHE, respectively, for the onset and half-wave potentials. The better activity of the nanorod morphology compared to its bulk counterpart is attributed to the better exposed active sites due to the confined growth of the FePDC phase on the ZnO nanorod surface. Further, upon removing the ZnO template, additional active sites present in the inner side are also getting exposed, thereby enabling FeHCNR to record the highest onset potential of 0.97 V and E_{1/2} of 0.79 V vs. RHE among the three systems. It should be noted that, the values recorded on FeHCNR are closely matching with those on the state-of-the-art Pt/C catalyst, which has an onset potential and E_{1/2} of 0.99 and 0.84 V vs. RHE, respectively.

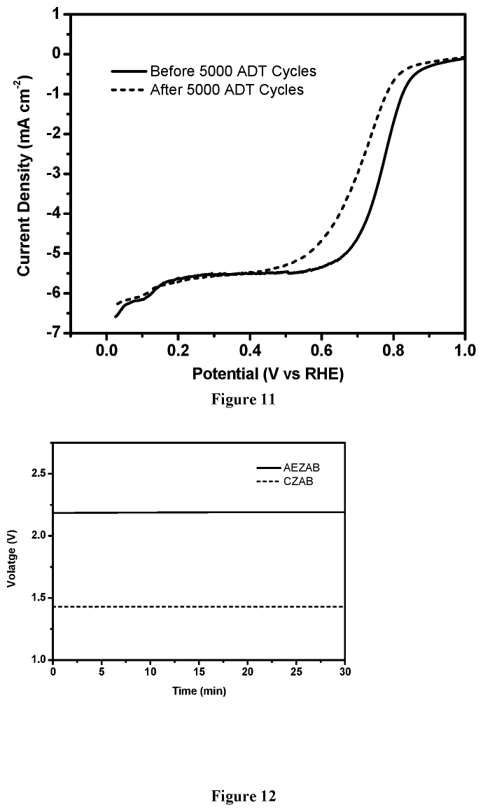

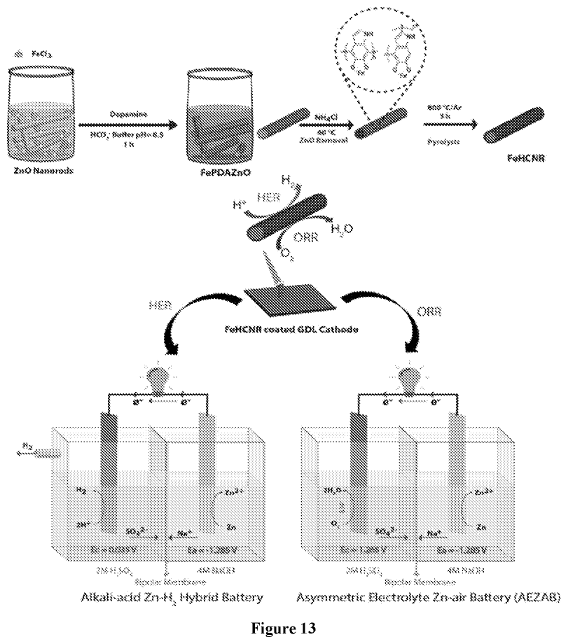

In addition to the improved ORR activity, it is significant to evaluate the catalyst's stability in an electrochemical environment to ensure its potential for real-world applications in realistic device level explorations. The stability tests were carried out by extensively cycling the potential between 0.60-1.0 V vs. RHE at 100 mV s⁻¹ in O₂-saturated electrolytes and subsequently quantifying the change in the E_{1/2} values after the corrosive accelerated durability test (ADT). The set triggered conditions for ADT can degrade the carbon surface and dopants along with the catalytically active metal centers. Also, at the same electrochemical situation, the ADT for the state-of-the-art Pt/C incurred a 52 mV decrease in E_{1/2} (FIG. 11). The huge difference discovered in the instance of Pt/C could be owing to the Pt nanoparticles detaching and agglomerating from the carbon support. Contrary to this, in the case of FeHCNR, Fe—Nₓ active sites are well connected to the carbon framework, and are considered to be very stable against leaching or aggregation during the potential cycling. In an embodiment, the present invention relates to an Iron-doped hollow carbon nanorod (FeHCNR) prepared by a process as disclosed in the present invention.

In another embodiment, the present invention relates to an alkaline-acid Zn—H₂ hybrid battery and an asymmetric-electrolyte Zn-air battery comprising as synthesized iron-doped hollow carbon nanorod (FeHCNR) coated on the surface of the cathode for the simultaneous generation of hydrogen and electricity.

In an embodiment of the present invention, an alkaline-acid Zn—H₂ hybrid battery comprising of FeHCNR, wherein said FeHCNR is brush-coated on the surface of a carbon paper as the cathode; catholyte; a Zn plate as the anode; and anolyte.

In another aspect of the present invention, the present invention discloses a bifunctional electrocatalyst based alkaline-acid Zn—H₂ hybrid battery, comprising a) a cathode comprising an iron-doped hollow carbon nanorod (FeHCNR) is brush-coated onto a surface of a carbon paper; b) an acid catholyte; c) an anode comprising a Zn plate; and d) an alkaline anolyte.

### Alkaline-Acid Zn—H₂ Hybrid Battery

The FeHCNR brush-coated on the surface of a carbon paper as the cathode with 2 M H₂SO₄ as the catholyte and a commercial Zn plate as the anode with 4 M NaOH as the anolyte were used to make the alkaline-acid Zn—H₂ hybrid battery (Scheme 1). The energy of Zn oxidation as well as the electrochemical neutralization of the acid and base can both be collected here. A bipolar membrane (BPM) separated the anode and cathode chambers to avoid direct neutralization of the anolyte and catholyte with the evolution of heat energy. The commercially available cation exchange and anion exchange membranes were laminated to make BPM. At the anode, Zn is oxidized in an alkaline solution (Equation 1), which is followed by electron transfer through an external circuit, resulting in the release of electrochemical energy. Proton reduces electrochemically by employing this electron, resulting in the hydrogen evolution reaction in the acid medium at the cathode (Equation 2). The cation and anion exchange membranes separate Na⁺ and SO₄²⁻, which are then transferred into a water layer; there is no crossover between the two electrode chambers. According to the Nernst equation, the as-developed Zn—H₂ hybrid battery can theoretically provide an open-circuit voltage of 1.32 V.

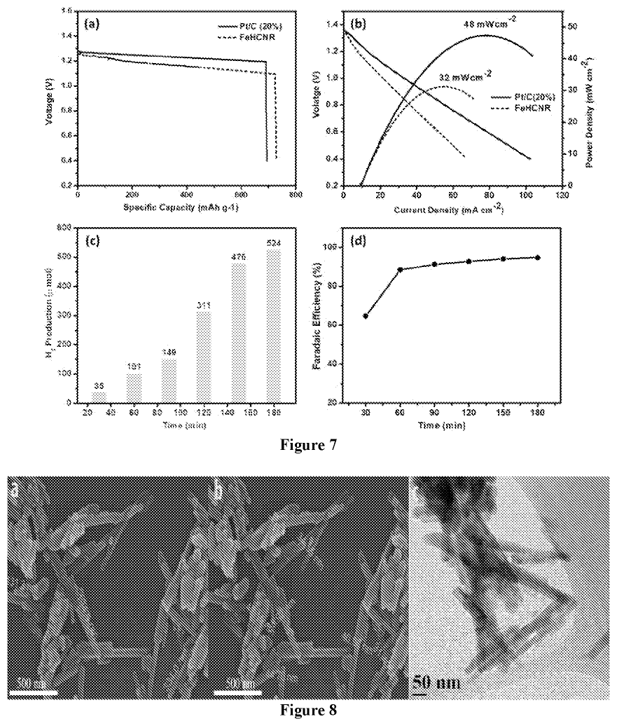

The comparison of the discharge profiles (FIG. 7a) demonstrates the superiority of FeHCNR over Pt/C in terms of specific capacity. The system based on FeHCNR delivered a specific capacity of 728 mA h g⁻¹, which is higher than that of its counterpart systems based on PtC (690 mA h g⁻¹). Furthermore, for the FeHCNR and Pt/C based systems, the maximum energy density was estimated to be 903 and 874 Wh kg⁻¹, respectively. The polarization curve and power density plot for Zn—H₂ hybrid battery with FeHCNR cathode catalyst are shown in FIG. 7b. The FeHCNR system has a maximum power density of 32 mW cm⁻², whereas the corresponding system based on Pt/C has a maximum power density of 48 mW cm⁻².

Gas chromatography (GC) was used to record the generated hydrogen volume to illustrate the hydrogen production efficiency during the discharge phase of the hybrid device. A micro syringe (500 μL) was used to collect the generated gas from the headspace and inject it into the GC. At a discharge current density of 5 mA cm⁻², FIG. 7c shows the amount of H₂ generated as well as the running time. Thus, this demonstration verifies that the device produces hydrogen and electrochemical energy simultaneously. The calculated and measured hydrogen productions are well-matched, implying a high Faradic efficiency for H₂ generation. The Faradic efficiency, which approaches 97% at various operating stages, corroborates this observation (FIG. 7d). It should be noted that the low Faradic efficiency of 65% was obtained at first, which is primarily due to the fact that the H₂ could not leave the carbon cloth texture in time and also due to the possibility of ORR as a side reaction.

### Asymmetric-Electrolyte Zn-air Battery (AEZAB)

As shown in Scheme 1, an asymmetric-electrolyte Zn-air battery (AEZAB) was built with NaOH as the anolyte and H₂SO₄ as the catholyte, both separated by BPM with FeHCNR as the cathode catalyst. Theoretically, AEZAB is capable of producing an output voltage of 2.55 V by utilising the electrochemical neutralization energy generating from the anolyte and catholyte, which contributes an extra voltage difference of 0.9 V to the theoretical voltage of the zinc-air battery (1.65 V).

For the comparison purpose, a symmetric conventional Zn-air battery (CZAB) was also developed by using 4.0 M NaOH as electrolyte and FeHCNR as the air electrode. The CZAB displays a low OCV (1.42 V) value compared to AEZAB; the later one shows an OCV of 2.18 V. The OCV profile of both AEZAB and CZAB recorded for 30 min are presented in FIG. 12, where the straight-line graph indicates the stability and feasibility of the device. In an embodiment, the present invention provides polydopamine derived iron-doped hollow carbon nanorod (FeHCNR) which has been prepared by a process involving selected removal of the structure directing template, followed by high-temperature annealing. The hollow structure promotes rapid mass transfer and greater active site exposure, resulting in increased electrochemical activity in hydrogen evolution and oxygen reduction reactions (HER and ORR, respectively). In 0.5 M H₂SO₄ electrolyte, FeHCNR showed outstanding HER and ORR activity, with an overpotential of 29.4 mV at a current density of 50 mA cm⁻² for HER and an onset potential of 0.97 V vs. RHE for ORR. Based on the better electrocatalytic activity displayed by FeHCNR towards HER, the catalyst has been utilized as the cathode for demonstrating a type of alkaline-acid Zn—H₂ hybrid battery by linking the Zn oxidation reaction with HER as the half-cell reactions occurring in the anode and cathode, respectively. With an open-circuit voltage of 1.28 V, a power density of 32 mW cm⁻², and hydrogen production ability with a Faradaic efficiency of 97%, the proposed hybrid Zn—H₂ battery is found to have the potential to generate H₂ and energy simultaneously. Furthermore, the remarkable ORR activity of FeHCNR in acidic medium has been exploited for fabricating an asymmetric-electrolyte Zn-air battery (AEZAB) by clubbing the Zn oxidation in the anolyte and ORR in the catholyte. This system provided an open circuit voltage of 2.15 V and a power density of 69 mW cm⁻². In this regard, the present invention not only demonstrates the potential to explore a novel bi-functional electrocatalyst which can ensure simultaneous production of hydrogen and energy but it also points towards the feasible opportunities and cost-effective solutions for the designing of more energy efficient systems for many futuristic applications.

### EXAMPLES

Following examples are given by way of illustration and therefore should not be construed to limit the scope of the invention.

Reagents: Chemicals of the analytical grade were used as purchased without further purification. Zinc acetate dihydrate (Zn (OAc) 2.2H₂O), poly (ethylene glycol) (average molecular weight 400, PEG-400), ethanol (C₂H₅OH), sodium hydroxide (NaOH), dopamine hydrochloride (purity 98%) and iron (III) chloride (FeCl₃, 98%), were obtained from Sigma-Aldrich. Sulphuric acid H₂SO₄) was procured from Thomas Baker.

### Example 1: Preparation of ZnO Nanorods

The ZnO nanorod was prepared by following a previously reported procedure. In a typical process, about 1.15 g of Zn(OAc)₂.2H₂O, 7.5 ml of PEG-40 and 3.0 g of NaOH were mixed in 30 ml of ethanol and kept for ultrasonication for about 30 minutes at room temperature. Subsequently, in a 50 mL Teflon-lined stainless-steel autoclave, the above mixture was kept at 120° C. for 12 hours. The resulting product was washed with distilled water and ethanol for five times. Afterwards, the white powder was dried in a vacuum oven at 60° C. for future use.

### Example 2: Preparation of FeHCNR

For preparing FeHCNR, about 20 mg of already synthesized ZnO nanorod and 1 mM FeCl₃ were dissolved in 10 ml bicarbonate buffer (pH of 8.5) solution containing 10 mg of dopamine hydrochloride. Then, the solution was kept for stirring at room temperature for 60 min. As the pH induced oxidation progresses, the color of the solution gradually turned dark brown and the dopamine gets self-polymerized over the ZnO to form PDA covered ZnO nanorods (FePDAZnO). Thus obtained FePDAZnO was separated by centrifugation before being rinsed with deionized water. The obtained product was then vacuum dried at ambient temperature. To etch out the ZnO template, FePDAZnO was added into a 2 M aqueous solution of NH₄Cl and the suspension was kept to stir for 20 min at 60° C. Lastly, the ZnO-free iron doped PDA nanorods were attained by centrifugation, washing with deionized water and drying using a vacuum oven at 60° C. The material was subsequently annealed at 800° C. under Ar atmosphere for 2 hours followed by treatment with 0.5 M H₂SO₄ at 60° C. to eliminate the non-reactive and unstable residues. Thus, obtained material after washing three times with water and drying is designated as FeHCNR. Also, for the comparative study, a control sample without a hollow structure has been prepared by directly annealing FePDAZnO at 800° C. under Ar atmosphere for 2 hours and the obtained sample is named as FePDCZnO. Whereas FeHCNR has a hollow tubular morphology with the well-coordinated Fe—C—N type active sites exposed along the inner and outer walls of the rods, the ZnO core present in the FePDCZnO lacks the hollow nature and its active sites are exposed only along the outer surface.

### Example 3: Characterization

Morphological features were investigated using a scanning electron microscope (SEM, Quanta 200 3D FEI instrument) and transmission electron microscope (TEM) using the FEI Technai G2 T20 instrument, which was operated at 200 keV. Powder X-Ray diffraction (PXRD) profiles were recorded to check the crystallinity with the help of a PANalytical X'pert Pro instrument using Cu Kα (1.5418 Å) radiation with a scan rate of 5° min⁻¹. Thermogravimetric analysis (TGA) was performed at a heating rate of 10° C. min⁻¹ under O₂ atmosphere from 25 to 900° C. to determine the metal loading over the carbon using an STD Q600 DSC-TDA thermogravimetric instrument. The Raman spectra were recorded on an HR 800 RAMAN spectrometer (Jobin Yvon, Horiba, France) equipped with a 632.1 nm red laser. Using a VG Microtech Multilab ESCA 3000 spectrometer, X-ray photon emission spectroscopic (XPS) analysis of the samples was performed. The specific surface area, pore size distribution and pore volume were studied by utilizing a Quantachrome Quadrasorb automatic volumetric instrument at a temperature of 77 K. Electrochemical characterizations were done by using the Pine Research Instrument's rotating disk electrode (RDE) and rotating ring disk electrode (RRDE) setup connected to a BioLogic VMP-3 PG Stat.

### Example 4: Catalyst Slurry Preparation

The catalyst slurry was prepared by mixing 5.0 mg of the prepared catalyst in 1.0 ml of water: isopropanol (3:2) solution and 5 wt % Nafion. The mixture was kept for 30 min under ultra-sonication. A 10 μl aliquot was coated over the rotating disk electrode (RDE), resulting in a catalyst loading of around 0.225 mg/cm².

### Advantages of the Invention

The present invention provides a simple strategy to overcome issues related to the cost and efficiency of the hybrid energy harvesting system. An acid-base Zn—H₂O fuel cell can simultaneously generate hydrogen fuel and utilizes the energy of Zn oxidation and neutralization between acid and base. This process helps to improve the efficiency of the conventional hydrogen production systems known to exist now. Direct neutralization of acid and base in the different electrode chamber is prevented by keeping a bipolar membrane between them. H₂ production occurs electrochemically with hydrogen evolution reaction in the acid medium at cathode and Zn oxidation reaction in the basic medium at anode, associated with an electron transfer via an external circuit.

We claim:

1. A bifunctional electrocatalyst, comprising:
an iron-doped hollow carbon nanorod (FeHCNR);
wherein an iron metal in the FeHCNR comprises mixed phases of Fe₃C and Fe₃N; and
wherein the FeHCNR has a mesoporous structure with a BET surface area in a range of 202-204 m²g⁻¹ and a total pore volume in a range of 0.42-0.44 cm³ g⁻¹.

2. The electrocatalyst as claimed in claim 1, wherein the electrocatalyst has an open-tube cavity and high-density active sites exposed along with outer and inner walls to improve mass diffusion and electrocatalytic activity.

3. The electrocatalyst as claimed in claim 1, wherein the bifunctional electrocatalyst is a noble metal-free catalyst and is capable of generating hydrogen and electricity simultaneously.

4. A process for preparing a bifunctional electrocatalyst, the process comprising:
a) mixing a Zinc salt, a surfactant, and a buffer by ultrasonication for about 25-35 minutes at a temperature in a range of 25-30° C. to form a mixture;
b) autoclaving the mixture for 11-13 hours at a temperature in a range of 115-125° C. to form a product;
c) washing the product with distilled water and a first solvent to obtain a white powder;
d) drying the white powder in a vacuum oven at temperature in a range of 55-65° C. to obtain a dried white powder;
e) dissolving the dried white powder in a solution comprising FeCl₃ in a bicarbonate buffer solution containing a dopamine hydrochloride to form a solution mixture, wherein the bicarbonate buffer has a pH of 8.5;
f) stirring the solution mixture at temperature in a range of 25-30° C. for a time period of 55-65 minutes to obtain polydopamine covered ZnO nanorods (FePDAZnO);
g) centrifuging the FePDAZnO followed by rinsing with a second solvent to obtain rinsed FePDAZnO;
h) vacuum-drying the rinsed FePDAZnO to obtain a dried FePDAZnO;
i) mixing the dried FePDAZnO into an aqueous solution of NH₄Cl to form a suspension, wherein the suspension is further stirred for 18-22 minutes at temperature in a range of 55-65° C. to get a ZnO-free iron-doped PDA nanorods;
j) centrifuging the ZnO-free iron-doped PDA nanorods followed by washing with water, and subsequent drying using a vacuum oven at a temperature of 60° C. to obtain a material;
k) annealing the material at a temperature of 800° C. for 2 hours, followed by treating with H₂SO₄ at temperate of 60° C. to eliminate a non-reactive and a unstable residues; and
l) washing the material with water followed by drying to obtain pure FeHCNR.

5. The process as claimed in claim 3, wherein the zinc salt is zinc acetate dehydrate or zinc sulfate; and wherein the surfactant is poly (ethylene glycol) or diethylene glycol.

6. The process as claimed in claim 3, wherein the buffer is NaOH or KOH.

7. The process as claimed in claim 3, wherein the first solvent is ethanol and the second solvent is water.

8. A bifunctional electrocatalyst based alkaline-acid Zn—H₂ hybrid battery, comprising:
a) a cathode comprising an iron-doped hollow carbon nanorod (FeHCNR), brush-coated onto a surface of a carbon paper;
b) an acid catholyte;
c) an anode comprising a Zn plate; and
d) an alkaline anolyte.

9. The battery as claimed in claim 8, wherein the iron-doped hollow carbon nanorod (FeHCNR) acts as a bifunctional electrocatalyst in the battery for simultaneously generating hydrogen and electricity by asymmetric electrolysis with the acid catholyte and the alkaline anolyte.

10. The battery as claimed in claim 8, wherein the acid catholyte is 2 M H₂SO₄ and the alkaline anolyte is 4 M NaOH.

11. The battery as claimed in claim 9, wherein the bifunctional electrocatalyst has an open-tube cavity and high-density active sites exposed along with outer and inner walls to improve mass diffusion and electrocatalytic activity.

12. The battery as claimed in claim 9, wherein the bifunctional electrocatalyst is a noble metal-free catalyst.
